(19) United States
(12) Patent Application Publication
(10) Pub. No.: US 2014/0029919 A1
(43) Pub. Date: Jan. 30, 2014

(54) EDITING OF AN EVENT-BASED RECORDING

(71) Applicants: Rajnikanth Codavalli, San Jose, CA (US); Nigel Pegg, San Francisco, CA (US)

(72) Inventors: Rajnikanth Codavalli, San Jose, CA (US); Nigel Pegg, San Francisco, CA (US)

(73) Assignee: Adobe Systems Incorporated

(21) Appl. No.: 11/932,074

(22) Filed: Oct. 31, 2007

(51) Int. Cl. H04N 5/93

(52) U.S. Cl. 386/278; 386/281

(57) ABSTRACT

In some embodiments, a method includes retrieving a recording of a collaborative session that has been recorded as an event sequence. The recording includes at least one event. The method also includes locating at least one event in the recording of the collaborative session. The method includes performing an edit operation of the recording. The edit operation is at least one of a modification of the at least one event, a removal of the at least one event, or an addition of a new event relative to the at least one event.

### COPYRIGHT

A portion of the disclosure of this document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software, data, and/or screenshots which may be described below and in the drawings that form a part of this document: Copyright© 2007, Adobe Systems Incorporated. All Rights Reserved.

### BACKGROUND

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

Meetings among a number of participants may be held as collaborative sessions in an on-line meeting. In particular, applications now offer the ability to for participants to connect across the Internet to share voice, video and data in real time for meetings, presentations, training, etc.

### BRIEF DESCRIPTION OF THE DRAWINGS

The embodiments are provided by way of example and not limitation in the figures of the accompanying drawings, in which like references indicate similar elements and in which:

FIG. 1 is a network diagram of a system for editing of event-based recording of a collaborative session, according to example embodiments.

FIG. 2 is a screen shot of a Graphical User Interface (GUI) of a collaborative session, according to example embodiments.

FIG. 3 is a more detailed block diagram of a recording of a collaborative session, according to example embodiments.

FIG. 4 is a diagram of a method for editing of an event-based recording, according to example embodiments.

FIG. 5 is a diagram of a method for time-based nondestructive editing of an event-based recording, according to example embodiments.

FIG. 6 is a more detailed block diagram of a recording of a collaborative session having cut points for time-based nondestructive editing, according to example embodiments.

FIG. 7 illustrates a computer that may be used for versioning of modifiable electronic documents, according to example embodiments.

### DETAILED DESCRIPTION

Methods, apparatus and systems for editing of an event-based recording are described. In the following description, numerous specific details are set forth. However, it is understood that embodiments of the invention may be practiced without these specific details. In other instances, structures and techniques have not been shown in detail in order not to obscure the understanding of this description.

As used herein, the term “collaborative session” may comprise any type of sharing of multimedia data among two or more participants. For example, the collaborative session may be sharing of multimedia data among multiple participants using client devices that are coupled together over a network. An example of a collaborative session may comprise any type of online meeting. For example, the collaborative session may be an electronic presentation by one or more persons that is shared over a network other person(s). The electronic presentation may comprise various types of multimedia. Examples of the type of data that may be part of a collaborative session may be audio, video, slide presentations, a shared white board, display of polling results, chat log, a window that displays the participants, etc.

As used herein, the term “semantic-level edit operation” may comprise an edit operation of any type of event in a collaborative session. The event is any occurrence that is indicative of what is occurring during a collaborative session. The edit operation may include modifying an event, adding a new event relative to existing events, deleting an event, etc. The events of a collaborative session to be edited may include an addition of an entry in a chat log being displayed, an edit of a shared white board (being displayed) among participants in a collaborative session, changes in parts of a video (being displayed), edit of data on a slide being displayed as part of the collaborative session, etc. Accordingly, a semantic-level edit operation may be edits to any event being recorded and occurring as part of a collaborative session.

As used herein, the term “client device” refers to any type of device that may execute a software application. The client device may be a thin client, fat client, or a hybrid client. For example, client devices may include desktop computer, notebook computers, wireless/wired devices, mobile devices (such as cellular telephones, Personal Digital Assistants (PDAs)), media players (such as MP-3 devices), gaming consoles, set-top boxes, etc.

Example embodiments include the editing of event-based recording of a collaborative session. For example, multiple participants may be part of an online meeting, wherein the participants use client devices (that are coupled together through a network) to participant in the meeting. The collaborative sessions may comprise audio, video, chat pods, shared white boards, document presentations (such as a slide presentation), etc. In some embodiments, the recording is saved as a series of events. Examples of events may comprise the starting of a video or audio session, the entering or leaving of a participant from the meeting, modification in a layout of a window, the adding or hiding of data from the presentation, presence or absence of a participant from a video camera that is shown as part of the collaborative session, edits to a whiteboard, presentation of a participant poll, etc. Accordingly (as an example), after a user enters the meeting, the text for updating a user login window is stored as an event. If a window is resized, the pixel coordinates of such resizing is stored as an event. If the white board is modified, such modification is recorded, which includes the data on the white board that was modified. For example, if a picture is drawn, the coordinates the pixels are recorded. Such embodiments are in contrast to conventional techniques for recording a collaborative session. In particular, conventional techniques record the sessions as audio and video screen captures. Accordingly, editing of these types of recordings requires a video editor to edit the video (e.g., cut out parts of the video). In contrast, example embodiments are recorded as a series of events

Because the recording comprises a series of events, example embodiments may locate events therein and edit relative to such events. An event may be removed or edited. In some embodiments, a new event may be added to the recording. For example, certain windows may be removed because such the windows may not be relevant to persons viewing the playback. To illustrate, a window that displays which users are a part of the meeting may be removed. This may allow for the resizing of other windows, adding of a different window, etc. Because collaborative sessions are generally live recordings of an event, there may be more or more periods of dead time that could be edited from the playback. In another example, a user may insert offensive comments into the chat log. Such entries in the chat log may be located as an event and removed from the playback. In some embodiments, confidential data may have been presented in one or more slides. Accordingly, such slides may be located as events and removed from the playback.

Some embodiments include non-destructive editing of the playback of a recording. A playback editor may edit the recording to determine which events of a recording are part of the playback. In some embodiments, the playback editor may insert cut points along a timeline of the recording. The cut points are indicators to skip passed given events in a given time period during the playback. The cut points may become part of the recording, stored in a separate file and associated with the recording, etc. Thus, the recording remains unmodified.

After editing of the recording, some embodiments may convert the event-based recording into a video or audio file in accordance with any number of formats. For example, the recording may be converted into a Waveform audio format (wav) file for storage and playback on a Compact Disc, into a Moving Picture Experts Group (MPEG)-1 Audio Layer-3 (MP3) format, Flash Video (FLV) format, etc. for storage and playback on various devices, etc. Accordingly, such embodiments allow for portability of the recordings after the editing of event-based recording. In example embodiments, this conversion may be performed at a later stage relative to collaborative session. Accordingly, the conversion does not consume resources during a collaborative session.

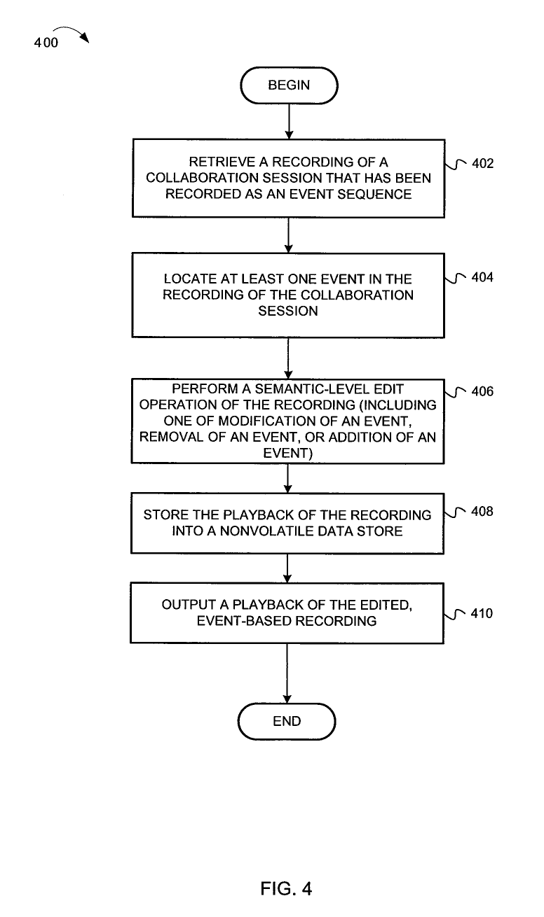

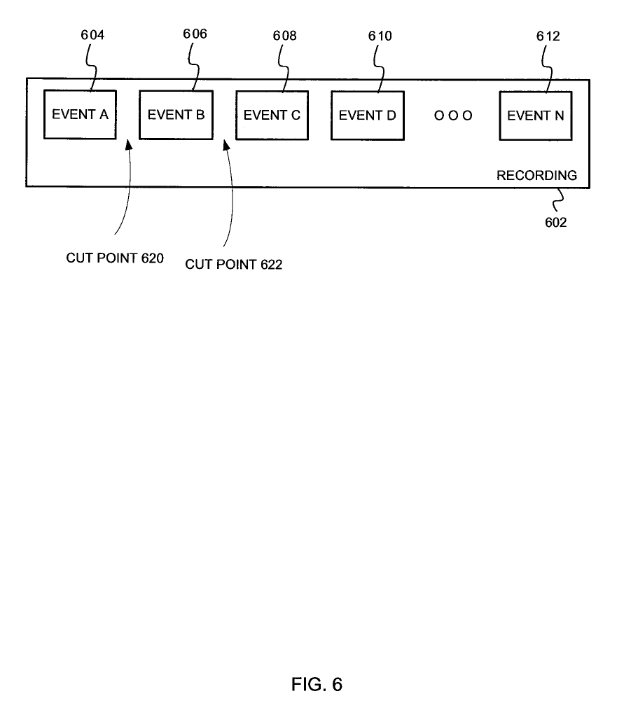

As further described below, example embodiments include two different operations for editing an event-based recording (event-based editing and time-based nondestructive editing). In some embodiments, the two different operations may be combined. Accordingly, one or more events of a recording may be edited (as illustrated in FIG. 4). Additionally, a time-based nondestructive editing of the same recording may be performed (as illustrated in FIG. 6).

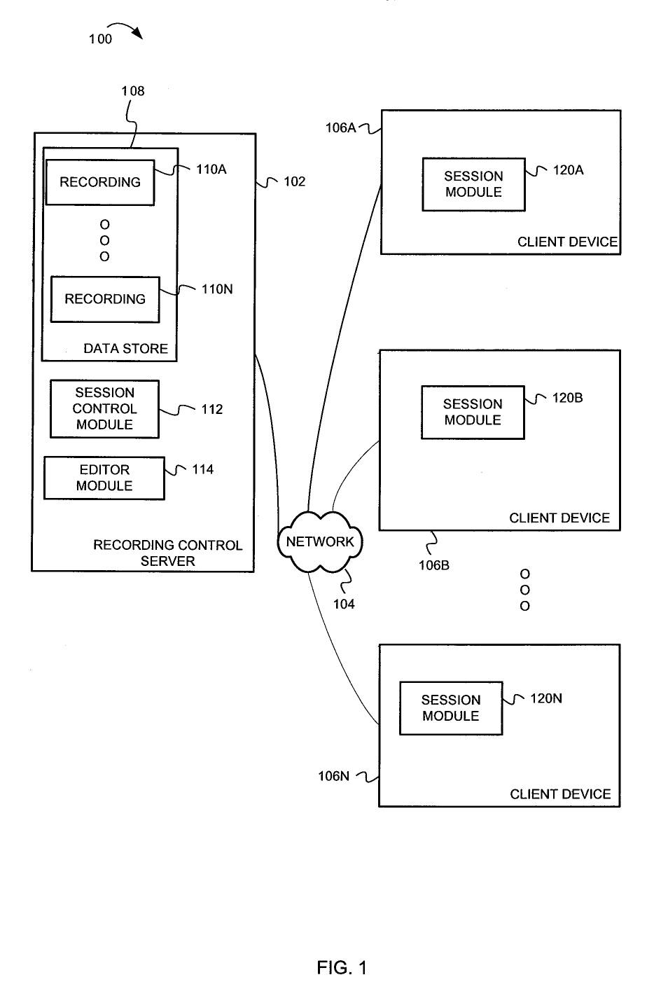

FIG. 1 is a network diagram of a system for editing of event-based recording of a collaborative session, according to example embodiments. A system 100 comprises a recording control server 102 and client devices 106A, 106B and 106N that are couple together through a network 104.

The recording control server 102 comprises a session control module 112, an editor module 114 and a data store 108. The data store 108 may store the recordings 110A-110N of the collaborative sessions. The session control module 112 may be control the collaborative sessions. For example, participants at the client devices 106 may be part of an on-line meeting that includes sharing of data, video, audio, etc. As further described below, the collaborative sessions may be a series of events or collaboration components. The session control module 112 may receive and forward these events among the different client devices 106 during the actual collaborative session.

The client devices 106A, 106B, 106N include session modules 120A, 120B and 120N, respectively. The session modules 120 may receive input that is received as part of a collaborative session and forward such input as an event to the session control module 112 on the recording control server 102. The session control module 112 may then forward such an event to the other client devices 106 that are part of the collaborative session. For example, after a user enters the collaborative session, an event is generated that includes an update to the window that displays the users that are part of the collaborative session. In another example, if a user adds an entry into the chat log, the entry is recorded as an event, which includes the data that the user entered into the chat log. In another example, if a user updates a white board, the pixel changes are recorded as an event.

As further described below, the editor module 114 performs various edits to a stored recording 110. The editor module 114 may remove or edits parts of a collaboration session (e.g., the chat log, a given entry in a chat log). The editor module 114 may add new events into a stored recording 110. For example, if additional slides are needed for explanation, the presentation of the slides may be introduced as events within the event sequence of the stored recording 110.

The system 100 may comprise any number of client devices 106. While described such that the recordings, the session control module 112 and the editor module 114 are in a same server, embodiments are not so limited. Alternatively or in addition, such recordings and modules may be distributed across any number of network storage devices/servers. In some embodiments, operations may be executed in a peer-to-peer architecture. Accordingly, the session control module 112, the editor module 114 and the storage of the recordings may be within one or more client devices.

The network communication may be any combination of wired and wireless communication. In some embodiments, the network communication may be based on one or more communication protocols (e.g., HyperText Transfer Protocol (HTTP), HTTP Secured (HTTPS), Real Time Messaging Protocol (RTMP), Real Time Messaging Protocol Secured/SSL (RTMPS) etc.). While the system 100 shown in FIG. 1 employs a client-server architecture, embodiments are not limited to such an architecture, and could equally well find application in a distributed, or peer-to-peer, architecture system. The session control module 112, the editor module 114 and the session modules 120 may be software, hardware, firmware or a combination thereof for executing operations, according to some embodiments.

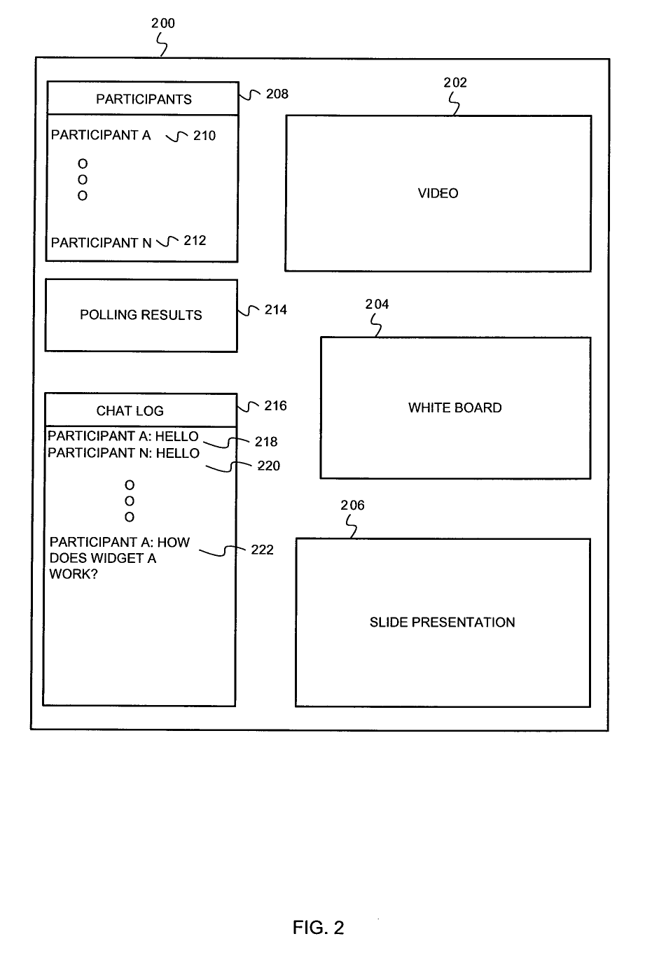

FIG. 2 is a screen shot of a Graphical User Interface (GUI) of a collaborative session, according to example embodiments. FIG. 2 includes a screen shot 200 that includes a video window 202, a white board window 204, a slide presentation window 206, a participants window 208, a polling results window 214 and a chat log window 216. The video window 202 may include streaming video of the participants, a video relevant to the collaborative session, etc. For example, the video window 202 may be segmented into a number of smaller windows for providing such video. The white board window 204 may be a shared board among the participants such that the participants may draw sketches, type in text, etc. that is shared among the participants. The slide presentation window 206 may be a window that displays the slides related to the collaborative session.

The participants window 208 may include entries that include the participants of the collaborative session. After a participant logs into the collaborative session, an entry with their identification is added to the participants window 208. In this example, an entry 210 is included for participant A, an entry 212 is included for participant N, etc.

The polling results window 214 may include the results of one or more polls conducted as part of the collaborative session. For example, the moderator may poll the different participants about different topics through the collaborative session. After the results are received, the poll results may be shown in the polling results window 214.

The chat log window 216 may include chat entries that provided by the different participants through the collaborative session. As examples, the chat log window 216 includes a chat entry 218, a chat entry 220, a chat entry 222, etc.

The screen shot 200 provides examples of an output that may be part of a collaborative session. Other example embodiments may include more or less such output. For example, additional windows for other type of data presentation, user interaction, etc. may be included as part of the collaborative session.

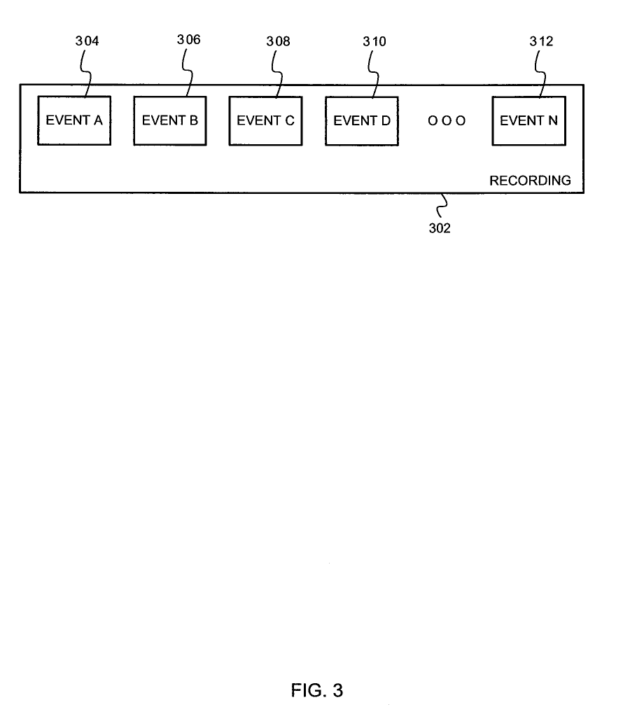

FIG. 3 is a more detailed block diagram of a recording of a collaborative session, according to example embodiments. FIG. 3 includes a recording 302 that includes event A 304, event B 306, event C 308, event D 310 and event N 312. Accordingly, the recording 302 may store data for one to any number of events regarding a collaborative session. The data for an event may be stored in the recording 302 as the collaborative session is occurring. The data for an event may vary depending on the event. For example, the initial window layout of the collaborative session may include five different windows, the coordinates, the colors, etc. for the five windows may be stored as an event. After a participant enters the collaborative session, an event is stored that participant the user, time of entry, etc. Accordingly, during playback, a window that shows the participants may be updated based on such data.

Operations, according to example embodiments, are now described. In certain embodiments, the operations are performed by instructions residing on machine-readable media (e.g., software), while in other embodiments, the methods are performed by hardware or other logic (e.g., digital logic). FIG. 4 is a diagram of a method for editing of an event-based recording, according to example embodiments. The flow diagram 400 is described with reference to FIGS. 1-3. In some embodiments, the flow diagram 400 is performed by the editor module 114. In example embodiments, the operations of the flow diagram 400 may occur after a collaborative session is complete and a copy of the recording is stored in the data store 108. The flow diagram 400 commences at block 402.

At block 402, the editor module 114 retrieves a recording of a collaborative session that has been recorded as an event sequence. As illustrated in FIG. 3, the recording may include storage of one or more events that occurred as part of the collaborative session. As described above, the events may comprise a window resizing (describing the change in terms of location), a participant entering or leaving the collaborative session, the displaying of a slide, the updating of a whiteboard, an entry in the chat log, etc. The flow continues at block 404.

At block 404, the editor module 114 locates at least one event in the recording of the collaborative session. In some embodiments, an individual may use the editor module 114 to replay the recording. For example, the individual may use the recording control server or any type of device coupled to the recording control server 102 to replay the recording. In example embodiments, the individual may mark events during playback. The editor module 114 may locate the events based on the markings from the individual.

The individual may delete events. For example, the individual may delete the chat log, the participants window, etc., if considered unneeded during subsequent playbacks. Thus, the editor module 114 may locate any event related to the chat log, participants window, etc. (display of the window, an entry therein, etc.). The individual may edit specific events of the playback. For example, the individual may modify an entry in the chat log. The individual may modify an edit that occurred as an event on the white board. For example, the individual may modify an input to the white board. The individual may edit that data on a slide of the slide presentation. Accordingly, the individual may mark such events during the playback. The individual may also add an event relative to other events in the recording. For example, the individual may add annotations to a particular slide, an edit to the white board, etc. The individual may add a link (e.g., a particular Web address) to access data at different parts of the recording.

Alternatively or in addition, the individual may use the editor module 114 to directly edit the recording. For example, the individual may edit directly in the recording. The individual may remove, edit or add events to the recording. The flow continues at block 406.

At block 406, the editor module 114 performs a semantic-level edit operation of the recording. The semantic-level edit operation may include modification, removal or adding of an event to the recording. As described above, the edit is based on an event and is semantic-related. In example embodiments, the editor module 114 does not edit relative to time slots from the recording. In particular, the editor module 114 does not cut time slices of the recording. Rather, the editor module 114 edits events therein. To illustrate, if an event is an entry in a chat log, the editor module 114 may edit the text of the entry. If an event is the presentation of a window (e.g., the chat log window), the editor module 114 may delete, resize, etc. the window. If an event is the presentation of a slide, the slide may be deleted, an additional slide may be added before or after the particular slide, data on the particular slide may be edited, etc. If an event is an edit of the data on a white board, the data may be deleted, added to, modified, etc. The flow continues at block 408.

At block 408, the editor module 114 stores the playback of the recording into a nonvolatile data store. With reference to FIG. 1, the editor module 114 may store the playback as a recording 110 in the data store 108. Accordingly, this edited recording may be distributed to various client devices for subsequent review of the playback. For example, if a person was unable to attend a collaborative session, the person may use a client device 106 to download the edited playback. The flow continues at block 410.

At block 410, the editor module 114 outputs the playback of the edited, event-based recording. As described above, the playback may be distributed to various client devices 106 for replay the collaborative session. In some embodiments, prior to outputting the playback, the editor module 114 may convert the playback (which is a series of events) into a multimedia files based on any of a number of different formats. The multimedia files may include any type of audiovisual coded data. For example, the editor module 114 may covert the playback into an MPEG (Moving Picture Experts Group) file (e.g., MPEG-2, MPEG-4, etc.), an audio file (e.g., WAV (Waveform Audio), MP3 (MPEG-1 Audio Layer 3), Flash Video (FLV) format, etc. Accordingly, the playback can be played a various devices (MP3 players, Compact Disc (CD) players, Digital Video Disc (DVD) players, etc.). The operations of the flow diagram 400 are complete.

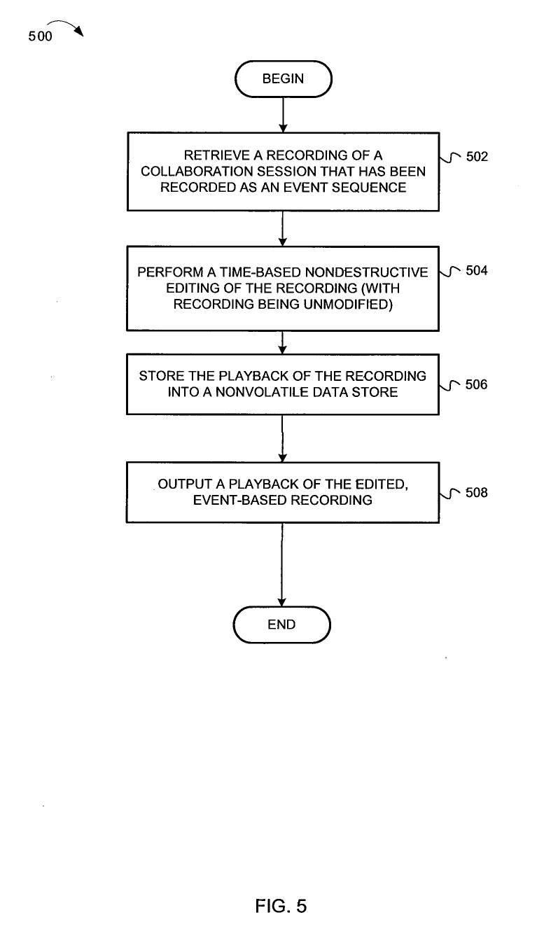

FIG. 5 is a diagram of a method for time-based nondestructive editing of an event-based recording, according to example embodiments. The flow diagram 500 is described with reference to FIGS. 1-3. In some embodiments, the flow diagram 500 is performed by the editor module 114. In example embodiments, the operations of the flow diagram 500 may occur after a collaborative session is complete and a copy of the recording is stored in the data store 108. The flow diagram 500 commences at block 502.

At block 502, the editor module 114 retrieves a recording of a collaborative session that has been recorded as an event sequence. As illustrated in FIG. 3, the recording may include storage of one or more events that occurred as part of the collaborative session. As described above, the events may comprise a window resizing (describing the change in terms of location), a participant entering or leaving the collaborative session, the displaying of a slide, the updating of a whiteboard, an entry in the chat log, etc. The flow continues at block 504.

At block 504, the editor module 114 performs a time-based nondestructive editing of the recording. To illustrate, FIG. 6 is a more detailed block diagram of a recording of a collaborative session having cut points for time-based nondestructive editing, according to example embodiments. Similar to FIG. 3, a recording 602 includes a number of events (event A 604, event B 606, event C 608, event D 610, and event N 612. Accordingly, the recording 602 may store data for one to any number of events regarding a collaborative session. The data for an event may be stored in the recording 602 as the collaborative session is occurring. As described above for the description of FIG. 3, the data for an event may vary depending on the event. As shown, a number of cut points have been inserted into the recording 602. One to any number of cut points may be inserted into the recording 602. In this example, a cut point 620 is placed between the event A 604 and the event B 606. A cut point 622 is placed between the event B 606 and the event C 608. The cut points are used to not play (e.g., skip play back of) certain parts of the recording 602 during a subsequent play back. In this example, the recording 602 would be replayed such that event B is skipped (from cut point 620 to cut point 622). In some embodiments, the cut points are inserted into the recording 602. Alternatively or in addition, the cut points may be stored separate from the recording 602 and referenced during playback. The cut points could be subsequently removed, changed, added to, etc. Accordingly, the recording 602 is nondestructively edited. The recording 602 may be returned to its original unedited state by removing these cut points. In some embodiments, a history of the nondestructively editing of a recording is maintained. Thus, the recording 602 may be returned to a prior edited state or its original state.

In example embodiments, a user may control the editor module 114 to insert the cut points into the recording 602 by reviewing a playback of the recording. In particular, the user may mark the cut points while replaying the recording on a GUI. In some embodiments, a timeline may be positioned within the GUI as the user is replaying the recording. In this example, after event A 604 occurs as part of the replay, the user may mark a cut point on the timeline. Similarly, after event B 606 occurs, the user may mark a second cut point. Thus, a subsequent playback does not include what occurs between the cut point 620 and the cut point 622. In some embodiments, alternatively or in addition to using a GUI editing, a user may use the editor module 114 to directly edit the recording 602. The flow continues at block 506.

At block 506, the editor module 114 stores the playback of the recording into a nonvolatile data store. With reference to FIG. 1, the editor module 114 may store the playback as a recording 110 in the data store 108. Accordingly, this edited recording may be distributed to various client devices for subsequent review of the playback. For example, if a person was unable to attend a collaborative session, the person may use a client device 106 to download the edited playback. The flow continues at block 508.

At block 508, the editor module 114 outputs the playback of the edited, event-based recording. As described above, the playback may be distributed to various client devices 106 for replay the collaborative session. In some embodiments, prior to outputting the playback, the editor module 114 may convert the playback (which is a series of events) into a multimedia files based on any of a number of different formats. The multimedia files may include any type of audiovisual coded data. For example, the editor module 114 may covert the playback into an MPEG (Moving Picture Experts Group) file (e.g., MPEG-2, MPEG-4, etc.), an audio file (e.g., WAV (Waveform Audio), MP3 (MPEG-1 Audio Layer 3), etc. Accordingly, the playback can be played a various devices (MP3 players, Compact Disc (CD) players, Digital Video Disc (DVD) players, etc.). The operations of the flow diagram 500 are complete.

While FIGS. 4 and 6 described two different operations for editing an event-based recording, in some embodiments the two different operations may be combined. Accordingly, one or more events of a recording may be edited (as illustrated in FIG. 4). Additionally, a time-based nondestructive editing of the same recording may be performed (as illustrated in FIG. 6).

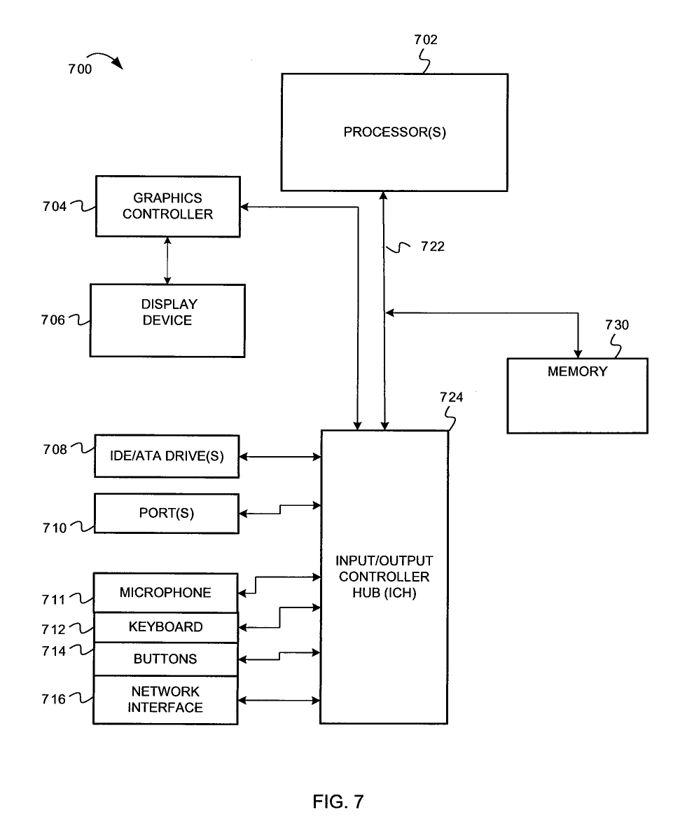

A detailed block diagram of an example computer environment, according to some embodiments, is now described. In particular, FIG. 7 illustrates a computer that may be used for versioning of modifiable electronic documents, according to example embodiments. A computer system 700 may be representative of one of the client devices, the servers, etc.

As illustrated in FIG. 7, the computer system 700 comprises processor(s) 702. The computer system 700 also includes a memory unit 730, processor bus 722, and Input/Output controller hub (ICH) 724. The processor(s) 702, memory unit 730, and ICH 724 are coupled to the processor bus 722. The processor(s) 702 may comprise any suitable processor architecture. The computer system 700 may comprise one, two, three, or more processors, any of which may execute a set of instructions in accordance with embodiments of the invention.

The memory unit 730 may store data and/or instructions, and may comprise any suitable memory, such as a dynamic random access memory (DRAM). The computer system 700 also includes IDE drive(s) 708 and/or other suitable storage devices. A graphics controller 704 controls the display of information on a display device 706, according to some embodiments of the invention.

The input/output controller hub (ICH) 724 provides an interface to I/O devices or peripheral components for the computer system 700. The ICH 724 may comprise any suitable interface controller to provide for any suitable communication link to the processor(s) 702, memory unit 730 and/or to any suitable device or component in communication with the ICH 724. For one embodiment of the invention, the ICH 724 provides suitable arbitration and buffering for each interface.

For some embodiments of the invention, the ICH 724 provides an interface to one or more suitable integrated drive electronics (IDE) drives 708, such as a hard disk drive (HDD) or compact disc read only memory (CD ROM) drive, or to suitable universal serial bus (USB) devices through one or more USB ports 710. For one embodiment, the ICH 724 also provides an interface to a keyboard 712, a mouse 714, a CD-ROM drive 718, one or more suitable devices through one or more Firewire ports 716. For one embodiment of the invention, the ICH 724 also provides a network interface 720 though which the computer system 700 can communicate with other computers and/or devices.

In some embodiments, the computer system 700 includes a machine-readable medium that stores a set of instructions (e.g., software) embodying any one, or all, of the methodologies for described herein. Furthermore, software may reside, completely or at least partially, within memory unit 730 and/or within the processor(s) 702.

In the description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that embodiments of the invention may be practiced without such specific details. In other instances, control structures, gate level circuits and full software instruction sequences have not been shown in detail in order not to obscure the embodiments of the invention. Those of ordinary skill in the art, with the included descriptions will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Embodiments of the invention include features, methods or processes that may be embodied within machine-executable instructions provided by a machine-readable medium. A machine-readable medium includes any mechanism which provides (i.e., stores and/or transmits) information in a form accessible by a machine (e.g., a computer, a network device, a personal digital assistant, manufacturing tool, any device with a set of one or more processors, etc.). In an exemplary embodiment, a machine-readable medium includes volatile and/or non-volatile media (e.g., read only memory (ROM), random access memory (RAM), magnetic disk storage media, optical storage media, flash memory devices, etc.), as well as electrical, optical, acoustical or other form of propagated signals (e.g., carrier waves, infrared signals, digital signals, etc.).

Such instructions are utilized to cause a general or special purpose processor, programmed with the instructions, to perform methods or processes of the embodiments of the invention. Alternatively, the features or operations of embodiments of the invention are performed by specific hardware components which contain hard-wired logic for performing the operations, or by any combination of programmed data processing components and specific hardware components. Embodiments of the invention include software, data processing hardware, data processing system-implemented methods, and various processing operations, further described herein.

In view of the wide variety of permutations to the embodiments described herein, this detailed description is intended to be illustrative only, and should not be taken as limiting the scope of the invention. What is claimed as the invention, therefore, is all such modifications as may come within the scope and spirit of the following claims and equivalents thereto. Therefore, the specification and drawings are to be regarded in an illustrative rather than a restrictive sense.

1. A method comprising:
retrieving a recording of a collaborative session that is a network-based multimedia sharing session between client devices of participants, the recording including an event forwarded from a client device of a participant among the participants;
locating, using at least one processor, the event in the recording of the collaborative session; and
modifying the recording of the collaborative session by performing an edit operation with respect to the event forwarded from the client device, the edit operation including a time-based non-destructive edit operation based on a cut point marked along a time line of the recording that is received from a user interface, the cut point being an indicator to skip over the event during a subsequent playback of the recording.

2. The method of claim 1, wherein the edit operation comprises deleting of a window that is part of a visual display of the collaborative session.

3. The method of claim 1, wherein the edit operation comprises editing data that is part of a slide that is part of a visual display of the collaborative session.

4. The method of claim 1, wherein the recording comprises a visual display having a number of windows, wherein the edit operation comprises resizing of at least one of the number of windows.

5. (canceled)

6. The method of claim 1, further comprising converting the recording into an audiovisual coded data.

7. The method of claim 1, further comprising:
storing the recording after performing the edit operation of the recording into a non-volatile data store; and
outputting the stored recording for subsequent playback.

8. A non-transitory machine-readable medium including instructions which when executed by at least one processor of a machine, cause the machine to perform operations comprising:
retrieving a recording of a collaborative session that is a network-based multimedia sharing session between client devices of participants, the recording including an event forwarded from a client device of a participant among the participants;
performing a time-based non-destructive editing of the recording without the event of the recording being modified, the non-destructive editing comprising:
receiving, from a user interface, at least one cut point marked along a time line of the recording adjacent to the event, the at least one cut point being an indicator to skip over the event during a subsequent playback; and
inserting the at least one cut point along the time line of the recording; and
performing a playback of the recording, the event forwarded from the client device being skipped over during the playback of the recording based on the at least one cut point that is inserted into the time line of the recording on the user interface.

9. (canceled)

10. The non-transitory machine-readable medium of claim 8, further comprising storing the at least one cut point separate from the recording.

11. The non-transitory machine-readable medium of claim 8, further comprising storing the at least one cut point within the recording.

12. (canceled)

13. The non-transitory machine-readable medium of claim 8, further comprising converting the recording into an audiovisual coded data.

14. The non-transitory machine-readable medium of claim 8, further comprising:
storing the recording after performing the editing of time ecording into a non-volatile data store; and
outputting the stored recording for subsequent playback.

15. The non-transitory machine-readable medium of claim 8, wherein performing the editing of the event comprises deleting the event from the recording.

16. The non-transitory machine-readable medium of claim 8, wherein the recording comprises a visual display having a number of windows, wherein performing editing of the at least one event comprises resizing of at least one of the number of windows.

17. A server comprising:
a non-transitory machine-readable medium to store at least one recording of a collaborative session that is a network-based multimedia sharing session between client devices of participants, the recording including an event forwarded from a client device of a participant among the participants; and
an editor module to locate the event in the recording, the editor module to modify the recording of the collaborative session by performing an edit operation with respect to the event forwarded from the client device, the edit operation including a time-based non-destructive edit operation based on a cut-point marked along a time line of the recording that is received from a user interface, the cut point being an indicator to skip over the event during subsequent playback of the recording.

18. The server of claim 17, wherein the edit operation comprises deletion of a window that is part of a visual display of the collaborative session.

19. The server of claim 17, wherein the recording comprises a visual display having a number of windows, wherein the edit operation comprises a resile of at least one of the number of windows.

20. (canceled)

21. The server of claim 17, wherein the editor module is to convert the recording into an audiovisual coded data.

22. The server of claim 21, wherein the audiovisual code data comprises Moving Picture Experts Group data.

23. (canceled)

24. The method of claim 1, further comprising:
receiving the event forwarded from the client device of the participant in the collaborative session;
forwarding the event to other client devices that are part of the collaborative session; and
recording the event.

25. The method of claim 1, wherein performing the edit operation comprises a selection from the group consisting of adding to the event, deleting from the event, deleting the event, and modifying the event.

26. The method of claim 1, wherein the event represents an action performed using the client device of the participant.

27. The method of claim 1, further comprising maintaining a history of nondestructive edit operations including cut points of the recording.

28. The method of claim 1, further comprising removing the cut point from the time line of the recording to return the recording to a unedited state.

29. The method of claim 1, wherein the edit operation includes a semantic level edit that edits an action within the event.
